(19) United States
(12) Patent Application Publication
(10) Pub. No.: US 2026/0008247 A1
(43) Pub. Date: Jan. 8, 2026

(54) Waste Compacting Apparatus

(71) Applicant: Cobalt Machinery Ltd, Middlesbrough (GB)

(72) Inventors: Steven EVERSHED, Middlesbrough (GB); Lawrence STRATTON, Middlesbrough (GB)

(21) Appl. No.: 19/251,783

(22) Filed: Jun. 26, 2025

(30) Foreign Application Priority Data
Jul. 2, 2024 (GB) 2409551.5
May 29, 2025 (GB) 2508361.9

(51) Int. Cl. B30B 9/30

(52) U.S. Cl. CPC B30B 9/3021; B30B 9/3057

(57) ABSTRACT

A waste compacting apparatus comprises an outer framework; an inner compacting chamber; a compaction plate assembly; and a waste ejection assembly for ejecting compacted waste from the apparatus. The inner compacting chamber comprises a pair of spaced apart side walls and a base, wherein the side walls and base are fixedly attached to the outer framework. The inner compacting chamber is positioned within the outer framework such that the side walls and the base of the inner compacting chamber locate within an interior space of a roll cage when a roll cage is introduced into the framework. The compaction plate assembly includes a press plate which is moveable between an upper position and a lower position within the inner compacting chamber such that waste within the inner compacting chamber is compacted by the press plate. The waste ejection assembly comprises at least one pusher plate configured to move between a retracted position located at a rear region of the inner compaction chamber, and an extended position located at a front region of the inner compaction chamber. A method for compacting waste using the apparatus is also disclosed.

### RELATED APPLICATIONS

This patent application claims the benefit and priority of Great Britain Application No. 2409551.5 filed Jul. 2, 2024 and Great Britain Application No. 2508361.9 filed May 29, 2025, the disclosures of which are incorporated by reference herein in their entirety as part of the present application.

### FIELD OF THE INVENTION

The present invention relates to apparatus for compacting waste.

### BACKGROUND OF THE INVENTION

Retail environments generate large quantities of paper and cardboard waste from packing and shipping materials. This waste accumulates quickly and occupies valuable storage space. Recycling and disposal of such waste is made easier by efficient compacting of the waste.

U.S. Pat. No. 4,232,599 describes a waste paper compacter in which waste is compacted by a compacting ram to form bales of waste material. The compacter includes a bale ejector in the floor of the apparatus in the form of a tilting element which causes the bale to be tipped out of the compacter. The bale can then be received onto a forklift or hand cart placed in front of the compacter. Such an arrangement would generally be suitable for the production and ejection of bales which have a low height relative to their width and some manual handling of the bale may well be required.

GB2569545 describes apparatus for compacting waste which is contained within a roll cage. Roll cages comprise a rectangular base with wheels beneath the base, and a three-sided cage framework extending upwardly from the base, with the cage open on one side. Roll cages are widely used for carrying and transporting goods but the cage framework is relatively light weight. The waste compacting apparatus described in GB2569545 allows waste to be compacted within a roll cage framework. The apparatus comprises a frame into which a roll cage filled with discarded packaging or other waste material is received. A pair of side plates then move inwardly to stabilise and support the sides of the roll cage during compaction of waste. Waste is then compacted by a pressure plate referred to as a, “platen” which is pressed downward by a hydraulic ram onto the waste in the roll cage. A pusher plate is then employed to urge the roll cage out of the apparatus. Material may be compacted in stages. The roll cage may be topped up with additional material in between the compaction stages. Roll cages have a modest weight limit, typically around 500 kg, so are at risk of damage if a large pressure is exerted on the waste held within the cage. This means that waste cannot be highly compacted. Roll cages also often have a folding inner shelf which could interfere with the pressure plate during compaction, causing damage to the roll cage.

It would be desirable to provide an improved waste compacting apparatus.

### SUMMARY OF THE INVENTION

According to one aspect of the invention there is provided a waste compacting apparatus comprising:
an outer framework;
an inner compacting chamber;
a compaction plate assembly; and
a waste ejection assembly for ejecting compacted waste from the apparatus;
wherein the inner compacting chamber comprises a pair of spaced apart side walls and a base, wherein the side walls and base are fixedly attached to the outer framework;
and wherein the inner compacting chamber is positioned such that the side walls and the base of the inner compacting chamber locate within an interior space of a roll cage when a roll cage is introduced into the framework;
and wherein the compaction plate assembly includes a press plate which is moveable between an upper position and a lower position within the inner compacting chamber such that waste within the inner compacting chamber is compacted by the press plate;
and wherein the waste ejection assembly comprises at least one pusher plate configured to move between a retracted position located at a rear region of the inner compaction chamber, and an extended position located at a front region of the inner compaction chamber.

The side walls of the inner compacting chamber may be substantially parallel, and may be substantially vertically oriented. The side walls may be mounted on the base of the inner compacting chamber.

The outer framework may comprise a base and a pair of side walls and the inner compacting chamber may be positioned within the outer framework such that the base of the inner compacting chamber is spaced apart from the base of the outer framework and the side walls of the inner compacting chamber are spaced apart from the side walls of the outer framework.

The press plate may be moveable by means of at least one press plate actuator. The press plate actuator may be selected from the group comprising: a piston and cylinder actuator, hydraulic ram, and a pneumatic ram.

The outer framework may support side walls spaced apart from the side walls of the inner compacting chamber. The side walls of the inner compacting chamber may be spaced apart from the side walls of the outer framework by a distance of between 100 and 300 mm.

The outer framework may comprise a base and the base of the inner compacting chamber may be spaced apart from the base of the outer framework by a distance of between 180 and 300 mm.

The at least one pusher plate may be moveable by means of a scissor mechanism and/or a pusher plate actuator. The pusher plate actuator may be selected from the group comprising: a piston and cylinder actuator, hydraulic ram, and a pneumatic ram.

The scissor mechanism may comprise at least one pair of scissor arms associated with the or each pusher plate, the scissor arms being pivotably connected to each other.

The scissor arms may be pivotably connected to each other at a midpoint of each scissor arm.

A first end of one of the scissor arms may be pivotably mounted to the pusher plate and a second end thereof may be slidably mounted to the outer framework, and a first end of the other of the scissor arms may be slidably mounted to the pusher plate and a second end thereof may be pivotably mounted to the outer framework.

The waste ejection assembly may comprise two pusher plates configured to move together between a retracted position located at a rear region of the inner compaction chamber, and an extended position located at a front region of the inner compaction chamber. Preferably, each pusher plate is moveable by means of a scissor mechanism and/or a pusher plate actuator.

At least one of the outer framework and the inner compacting chamber may be provided with a door. The door may be provided with a loading opening. The loading opening may be provided with a closing member.

The pusher plate of the waste ejection assembly may be arranged substantially perpendicular to the press plate of the compaction plate assembly.

A further aspect of the invention provides a method for compacting waste using the waste compacting apparatus as hereinbefore defined, the method comprising the steps of:
a) introducing waste into the inner compacting chamber of the apparatus;
b) compacting the waste within the inner compacting chamber by actuating the compaction plate assembly and causing the press plate to move from a retracted position downwards within the inner compacting chamber; and
c) returning the press plate to the retracted position.

The method may comprise the further steps of:
d) introducing further waste into the inner compacting chamber; and
e) repeating steps b) and c) until the inner compacting chamber is full.

The method may comprise the further steps of:
(f) introducing an empty roll cage into the outer framework of the apparatus such that the inner compacting chamber is contained within the roll cage; and
(g) actuating the waste ejection assembly and causing the at least one pusher plate to push compacted waste out of the inner compacting chamber and into the roll cage, causing the roll cage filled with compacted waste to be pushed out of the apparatus; and
(h) returning the at least one pusher plate to a retracted position

### BRIEF DESCRIPTION OF THE DRAWINGS

In the drawings, which illustrate preferred embodiments of the waste compacting apparatus of the invention and are by way of example:

FIG. 1 illustrates a perspective view of a waste compacting apparatus, shown with main door open;

FIG. 2 illustrates the apparatus of FIG. 1, shown with main door closed and loading door open;

FIG. 3 is a plan view of the apparatus of FIG. 1 with the main door and loading door closed;

FIG. 4 is a rear view of the apparatus of FIG. 1;

FIG. 5 is a simplified side view of the apparatus of FIG. 1, shown with the compaction press plate lowered;

FIG. 6 is a perspective view of the waste compacting apparatus of FIG. 1, shown with the ejection pusher plates in an extended configuration;

FIG. 7 is a simplified side view of the waste compacting apparatus of FIG. 6, with an inner compacting chamber wall removed for clarity;

FIG. 8 is a simplified side view of the waste compacting apparatus of FIG. 1, showing the ejection pusher plates in a retracted configuration;

FIG. 9 is a simplified perspective view of the apparatus illustrating the scissor mechanism at the rear of the pusher plates;

FIG. 10 is a simplified perspective view of the apparatus illustrating the scissor mechanism at the rear of the outer framework;

FIG. 11 illustrates the apparatus of FIG. 1 with a roll cage surrounding the inner compacting chamber;

FIG. 12 illustrates the ejection of a roll cage filled with compacted waste from the apparatus;

FIG. 13a is a partial schematic view of the apparatus of FIG. 1, illustrating the compaction plate assembly; and

FIG. 13b illustrates a simplified plan view of the apparatus of FIG. 1, illustrating the compaction plate assembly;

FIG. 14 is a simplified side view of a further example of a waste compacting apparatus, with an inner compacting chamber wall removed for clarity;

FIG. 15 is a schematic rear perspective view of the apparatus of FIG. 14, illustrating the scissor mechanism at the rear of the pusher plates;

FIG. 16 is a schematic front perspective view of the apparatus of FIG. 14 illustrating the scissor mechanism at the rear of the outer framework;

FIG. 17 is a is a plan view of the apparatus of FIG. 14 with the main door and loading door closed;

FIG. 18 illustrates a perspective view of a further example of a waste compacting apparatus, shown with main door open;

FIG. 19 is a rear view of the apparatus of FIG. 18;

FIG. 20 is a plan view of the apparatus of FIG. 18 with the main door and loading door closed;

FIG. 21 is a simplified side view of the apparatus of FIG. 18, with an inner compacting chamber wall removed for clarity;

FIG. 22 illustrates a simplified vertical cross-section through the apparatus of FIG. 21, shown with the compaction press plate lowered;

FIG. 23a is a schematic front perspective view of the apparatus of FIG. 18, illustrating the scissor mechanism at the rear of the outer framework;

FIG. 23b is an enlarged view of the circled section of the apparatus of FIG. 23a; and

FIG. 24 is a schematic rear perspective view of the apparatus of FIG. 18, illustrating the scissor mechanism at the rear of the pusher plates.

### DETAILED DESCRIPTION OF THE PREFERRED EMBODIMENTS

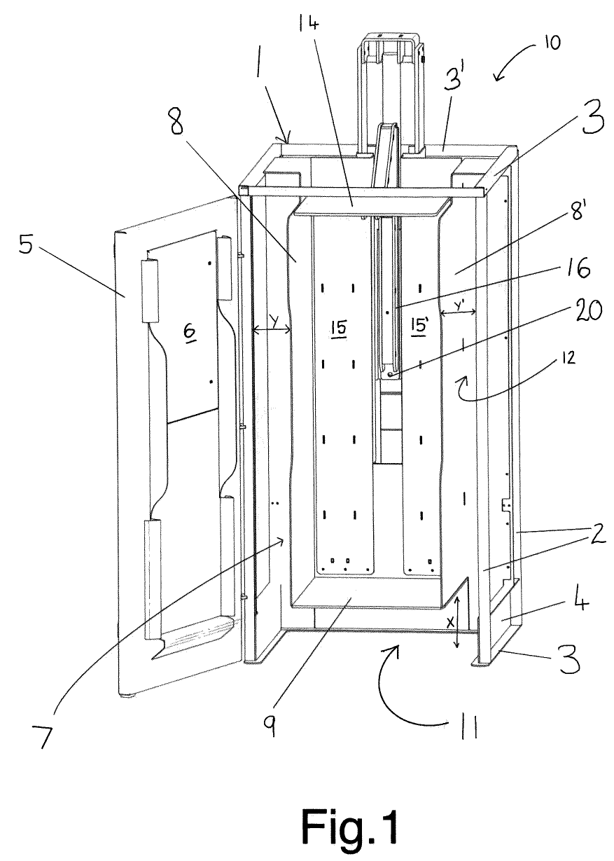

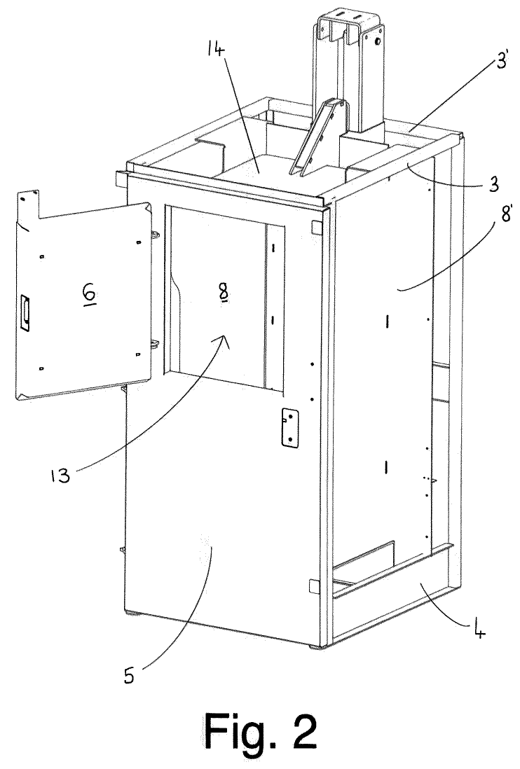

Referring now to FIG. 1, a waste compacting apparatus is shown generally at 10 and comprises an outer frame 1, including at least four vertical members 2, and horizontal members 3, 3′ joining the vertical frame members. The outer frame 1 may include side wall members 4 which each extend between two of the vertical members. The side wall members 4 may cover the entire side walls of the outer frame. As shown in FIG. 2, the front of the frame is provided with a hinged door member 5, which includes an opening 13 provided with a closing member in the form of a loading door 6. At floor level, the front of the frame does not include a horizontal frame member. This is so that there is no obstruction at the floor level and so that a roll cage can be easily rolled into and out of the outer frame.

Inside the outer frame there is provided an inner compaction chamber 7. The inner compaction chamber comprises a pair of side walls 8, 8′ mounted on a base 9. As illustrated in FIG. 1, the base 9 of the inner chamber is raised a distance X above the floor, providing a gap 11 underneath the base of the inner chamber. The side walls are also spaced apart a distance Y, Y′ from the sides of the outer frame, providing a gap 12 to either side of the inner compaction chamber. The side walls and base of the inner compaction chamber are fixedly attached to the outer frame.

When the main door 5 is closed, this door abuts the front edges of the side walls of the inner chamber and the door forms at least part of the front side of the inner compaction chamber. The loading door 6 allows waste to be introduced into the inner chamber through the opening 13, as illustrated in FIG. 2.

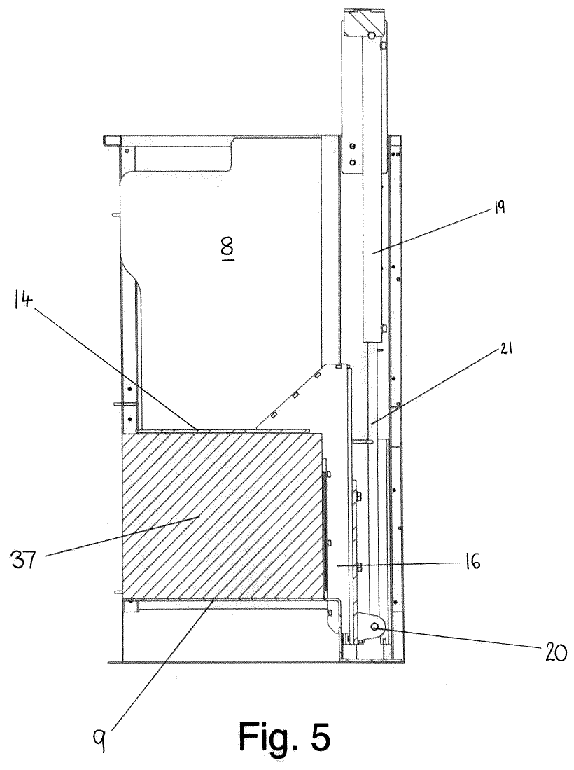

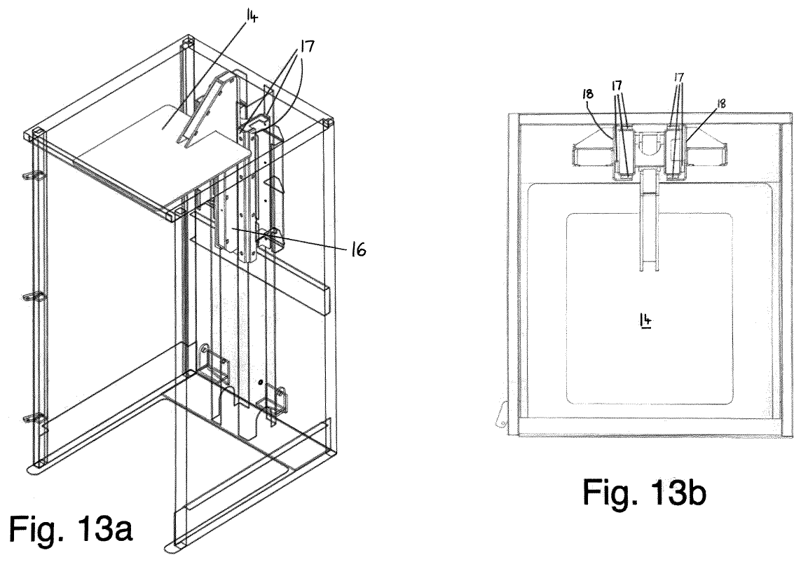

A compaction plate assembly includes a substantially horizontally oriented press plate 14 mounted on a substantially vertically oriented arm 16. The arm 16 is connected to a plurality of sliding members 17 (best shown in FIGS. 13a and 13b) which are arranged to slide up and down within vertical channels 18. The vertical channels 18 are attached to the rear of the outer frame. A press plate actuator in the form of a hydraulic ram 19 is positioned centrally at the rear of the outer frame 1, in between the vertical channels 18, and aligned with the vertical arm 16 of the compaction plate assembly. Other suitable actuator mechanisms may also be used. The compaction plate assembly is fixed to the piston 21 of the hydraulic ram 19, preferably via a bolted connection indicated at numeral 20. As the piston of the hydraulic ram extends vertically downwards, the sliding members 17 of the compaction plate assembly, along with the press plate 14 are also urged downwards. The stroke of the hydraulic ram is approximately 1 m. When the piston 21 of the hydraulic ram 19 is in an unextended position the press plate 14 rests towards the top of the inner chamber as shown in FIGS. 1 and 2. FIG. 5 illustrates the position of the press plate 14 with the arm of the hydraulic ram fully extended. In the simplified side view of FIG. 5, one of the inner chamber side walls 8′ has been removed for clarity.

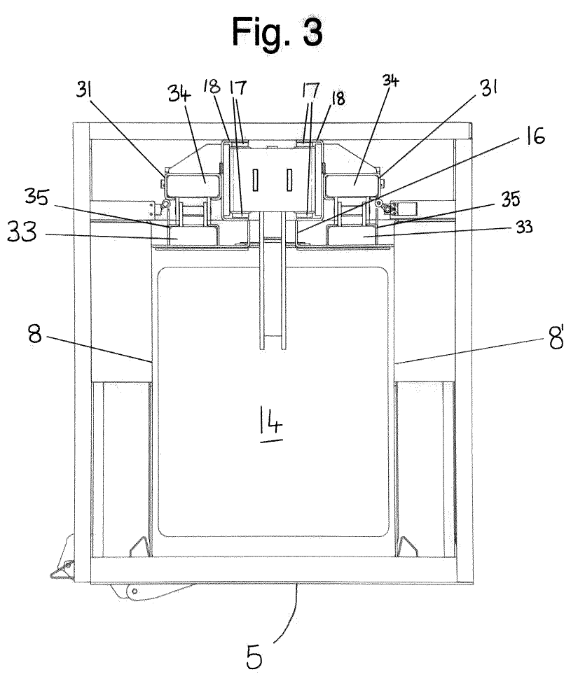

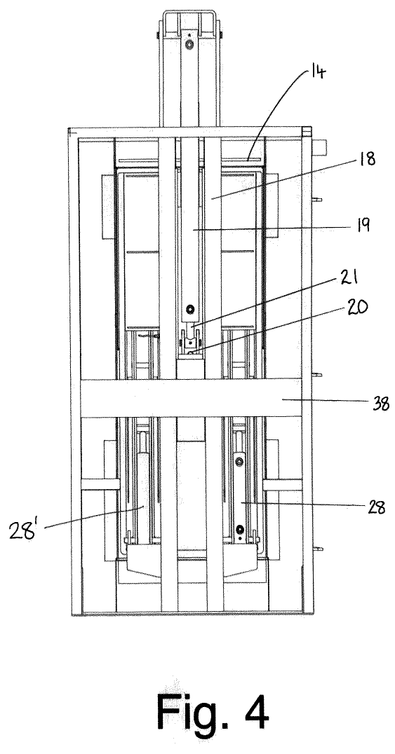

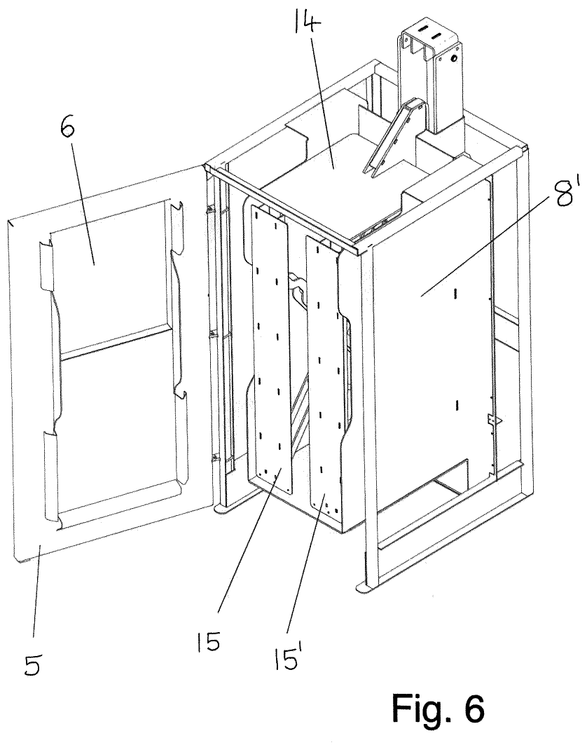

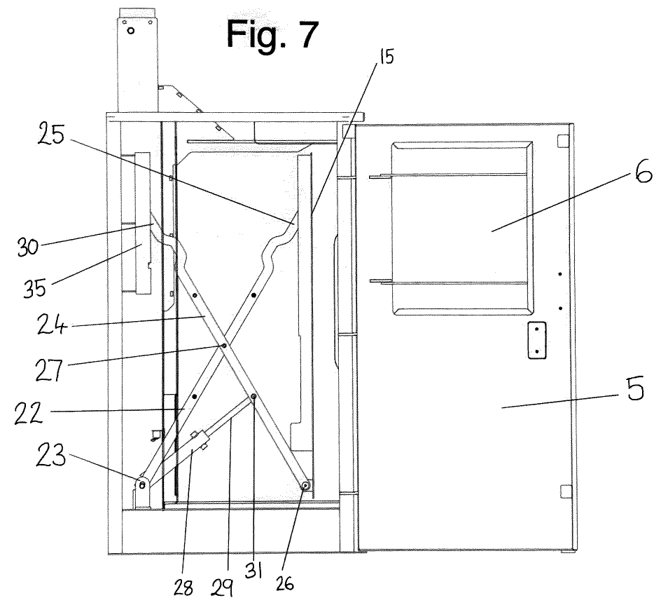

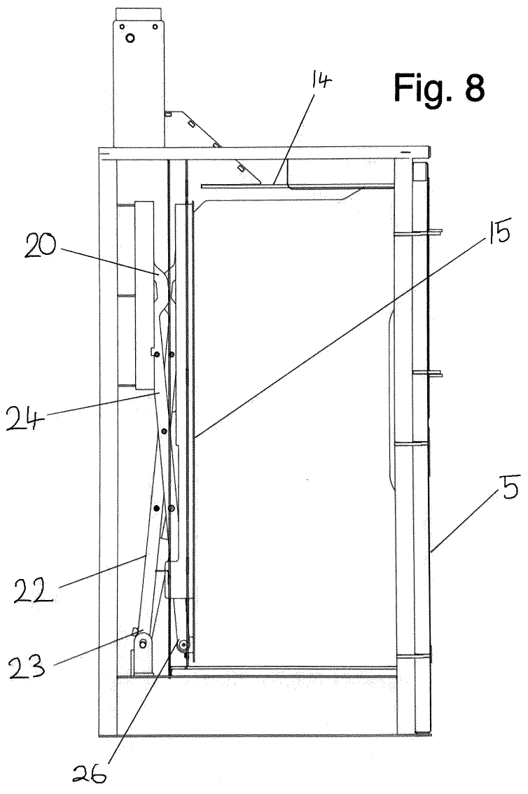

A mechanism for ejecting compacted waste from the apparatus comprises a pair of pusher plates 15, 15′ which are located at the rear of the inner chamber, towards the rear of the outer frame. A single pusher plate could also be used. The pusher plates 15, 15′ each preferably extend longitudinally along the full height of the inner compaction chamber. In the example illustrated in FIGS. 1 to 13b each pusher plate is mounted on a scissor mechanism which serves to retract the pusher plates 15, 15′ to the rear of the inner chamber 7, or to urge the pusher plates forwards. In FIG. 1 the pusher plates are in the retracted position, and in FIG. 6, the pusher plates 15, 15′ are shown in the extended position. The scissor mechanism of this example is best illustrated in FIGS. 7 to 10.

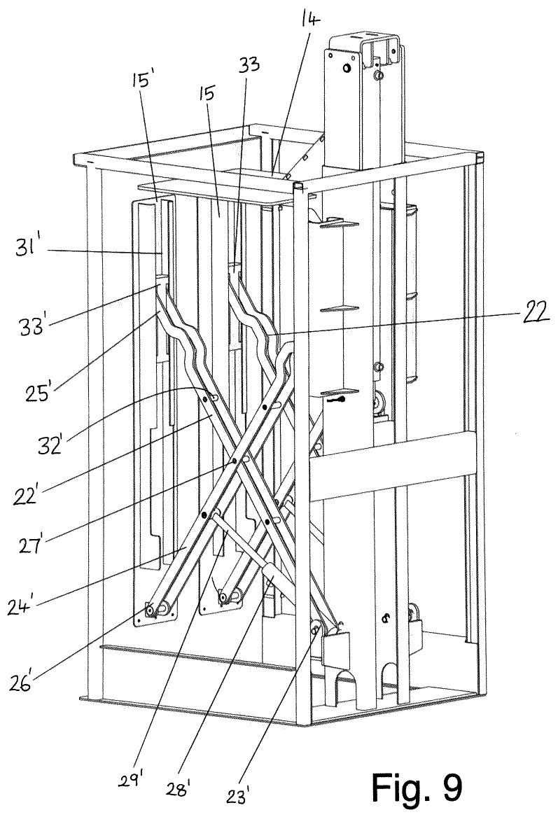

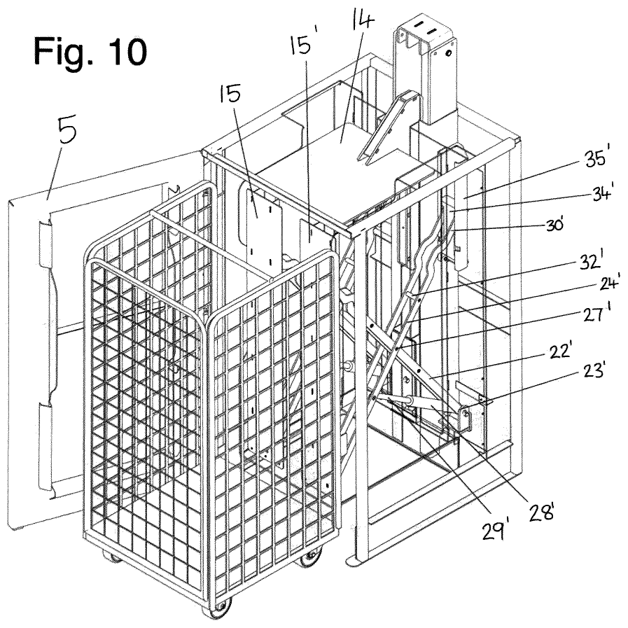

Each pusher plate 15, 15′ is provided with a pair of scissor arms 22, 24 connected together at a midpoint such that they may pivot with respect to one another. In the example illustrated in FIGS. 9 and 10 each scissor arm is in the form of a pair of parallel members which are connected together via bracing elements 32.

With reference to the first pusher plate 15, a first scissor arm 22 is pivotably connected to a second scissor arm 24 at a midpoint 27. The first scissor arm 22 is pivotably mounted towards the rear of the outer frame at a first end 23, and is slidably mounted to the pusher plate 15 at a second end 25. The slide mounting is better illustrated in FIG. 9 and comprises a sliding member 33 fixed to the second end 25 of the first scissor arm 22 such that the sliding member 33 may pivot with respect to the first scissor arm 22. The sliding member is located within a channel 31, such that the sliding member 33 can slide up and down within the channel 31.

The second scissor arm 24 is pivotably mounted to the bottom of the pusher plate 15 at a first end 26, and slidably mounted to the rear of the outer frame at a second end 30. The slide mounting is better illustrated in FIG. 10 and comprises a sliding member 34 fixed to the second end 30 of the second scissor arm 24 such that the sliding member 34 may pivot with respect to the second scissor arm 24. The sliding member is located within a channel 35, such that the sliding member 34 can slide up and down within the channel 35.

The scissor arm assembly for the second pusher plate 15′ is identical, and reference numerals have a prime suffix added.

Each of the scissor arm assemblies includes a pusher plate actuator, in this example a hydraulic ram 28, 28′, which is pivotably mounted to the rear of the outer frame. The piston 29, 29′ of each hydraulic ram 28, 28′ is pivotably mounted to the respective second scissor arm 24, 24′ at a location in between the midpoint 27, 27′ and the first end 26, 26′ of the second scissor arm, for example via a substantially horizontal pin 39. The hydraulic rams 28, 28′ are actuated simultaneously to move both pusher plates 15, 15′ at substantially the same rate. The hydraulic rams 28, 28′ may be provided with a flow equalization valve to equalise the flow of hydraulic fluid to each ram.

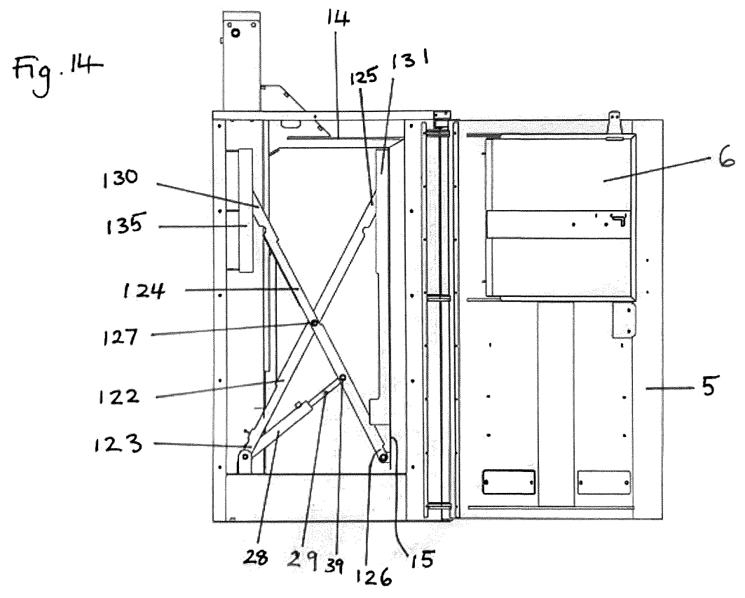

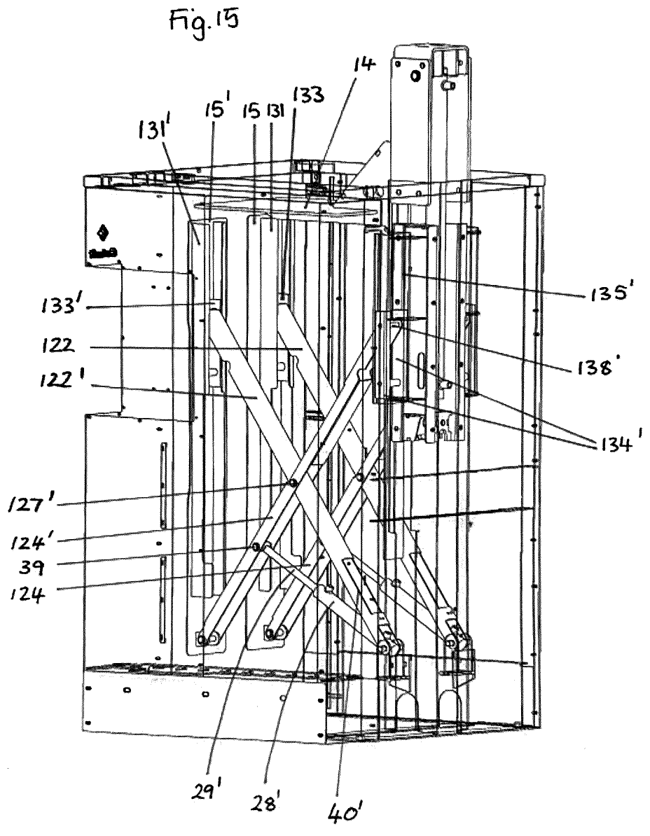

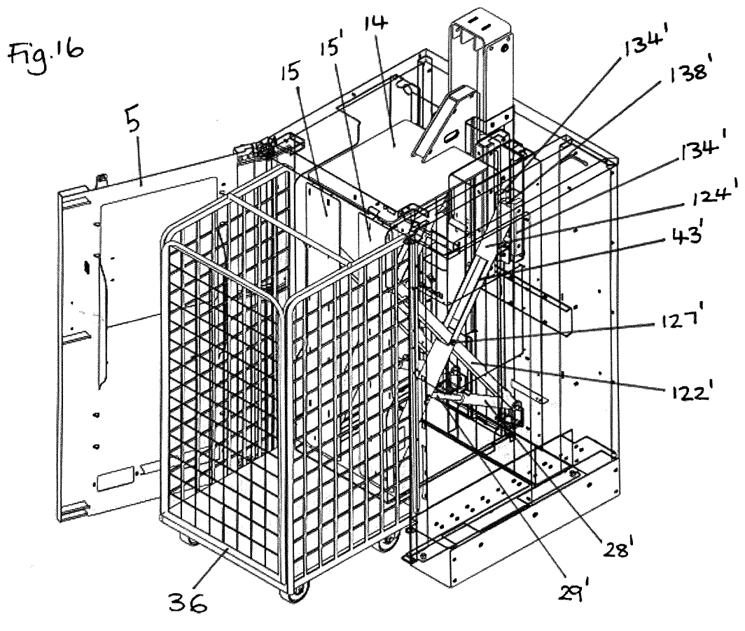

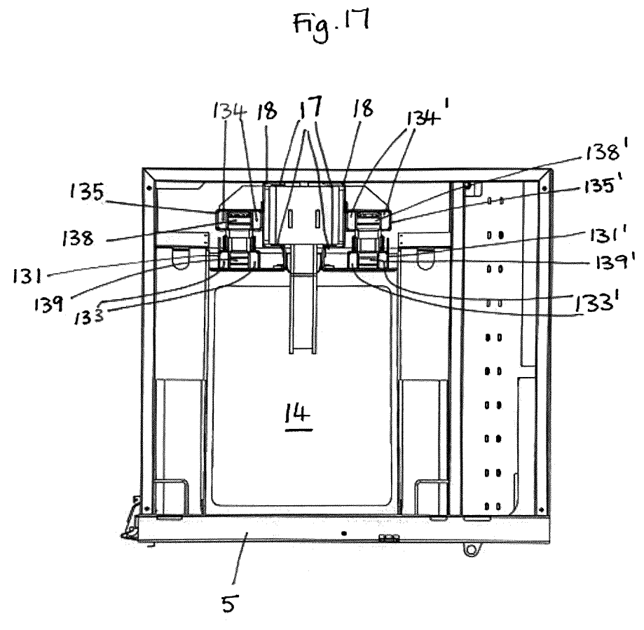

In an alternative example, as illustrated in FIGS. 14 to 17, each scissor arm pair may be in the form of a pair of channel sections 122, 124, 122′, 124′. Each pair of scissor arm channel sections are connected together at a midpoint 127, 127′ such that they may pivot with respect to one another. As shown in FIG. 14, each first scissor arm channel section 122, 122′ is pivotably connected to a second scissor arm channel section 124, 124′ at a midpoint 127, 127′. Each first scissor arm 122, 122′ is pivotably mounted towards the rear of the outer frame at a first end 123, 123′, and slidably mounted to a respective pusher plate 15, 15′ at a second end 125, 125′. In this example, as shown best in FIG. 15, each sliding member comprises a pair of spaced apart vertically oriented plates 133, 133′ which are fixed to the scissor arm channel via a substantially horizontal 139, 139′ such that the second scissor arms 124, 124′ may pivot with respect to the plates 133, 133′. The vertically oriented plates 133, 133′ forming the sliding member are located within a channel 131, 131′, such that the plates 133, 133′ can slide up and down within the channel 131, 131′.

Each second scissor arm 124, 124′ is pivotably mounted to the bottom of the respective pusher plate 15, 15′ at a first end 126, 126′ and slidably mounted to the rear of the outer frame at a second end 130, 130′. As shown in FIG. 15, the slide mounting comprises a sliding member fixed to the second end 130, 130′ of each second scissor arm 124, 124′. In a similar way to the first scissor arm, the sliding member comprises a pair of spaced apart vertically oriented plates 134, 134′ which are fixed to the second scissor arm 124, 124′ via substantially horizontal pins 138, 138′ such that the second scissor arms 124, 124′ may pivot with respect to the plates 134, 134′. The vertically oriented plates 134, 134′ forming the sliding member are located within a channel 135, 135′ such that the plates 134, 134′ can slide up and down within the channel 135, 135′.

The scissor arm channel sections each include cutaway sections 40, 43, 40′, 43′ which allow the scissor arm assemblies to retract fully.

Each of the scissor arm assemblies includes a hydraulic ram 28, 28′ which is pivotably mounted to the rear of the outer frame, in the same manner as for the examples of FIGS. 1 to 13b The piston 29, 29′ of each hydraulic ram 28, 28′ is pivotably mounted to the respective second scissor arm 124, 124′ at a location in between the midpoint 127, 127′ and the first end 126, 126′ of the second scissor arm, for example via a substantially horizontal pin 139. The hydraulic rams 28, 28′ are actuated simultaneously to move both pusher plates 15, 15′ at substantially the same rate. The hydraulic rams 28, 28′ may be provided with a flow equalization valve to equalise the flow of hydraulic fluid to each ram.

The ejection assembly could equally comprise a single or double hydraulic ram without the scissor mechanism.

To use the apparatus, the main door 5 is closed, the press plate 14 is raised and the pusher plates 15, 15′ are retracted to the rear of the inner compaction chamber. The loading door 6 is opened and an operator can introduce loose waste into the inner compaction chamber 7 through the opening 13.

When the inner compaction chamber 7 is full of loose waste the loading door 6 is closed and the compaction mechanism is operated. The press plate 14 is urged downwards by the hydraulic ram 19, compacting the waste below it. The press plate 14 is then returned to its rest position at the top of the inner chamber 7.

Further loose waste can now be introduced into the inner compaction chamber 7 via the loading door 6, and the compaction process can then be repeated. This process of loading and compaction continues until the inner compaction chamber 7 is full of compacted waste 37. Preferably the apparatus includes sensors which alert an operator when the inner compaction chamber 7 is full, such an alert may include a light on the exterior of the apparatus.

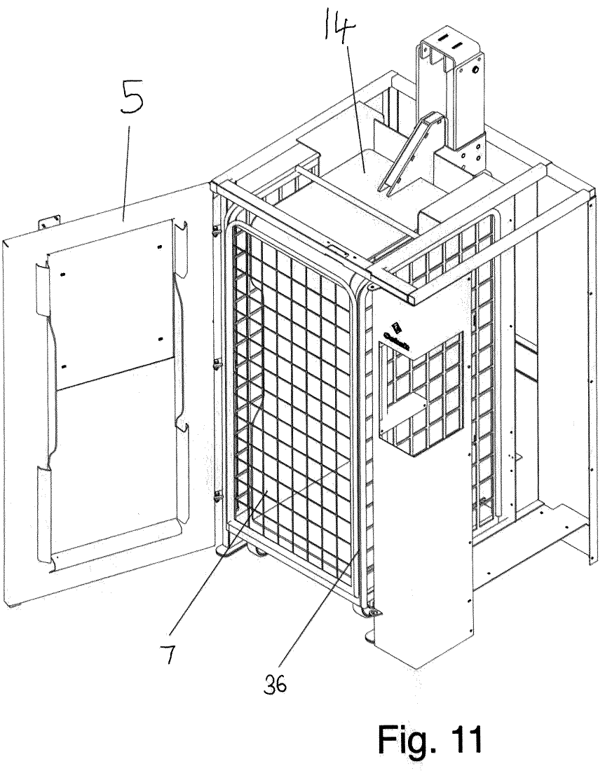

To empty the inner compaction chamber 7 the operator opens the main door 5 and pushes an empty roll cage 36 into the outer framework. As shown in FIG. 11, the inner compaction chamber 7 is positioned such that the whole of the inner compaction chamber 7 locates within the interior of the roll cage. The roll cage walls locate within the gap 12, 12′ to the sides of the inner chamber side walls 8, 8′; and the roll cage floor and wheels locate within the gap 11 underneath the base 9 of the inner chamber. For example, the base of the inner chamber may be spaced apart from the floor at distance of approximately 200 mm, and the sides of the inner chamber may be spaced apart by distance of approximately 600 mm. This allows the inner chamber to fit comfortably within the internal space of a roll cage with an internal width of approximately 750 mm and base height of approximately 180 mm from the floor.

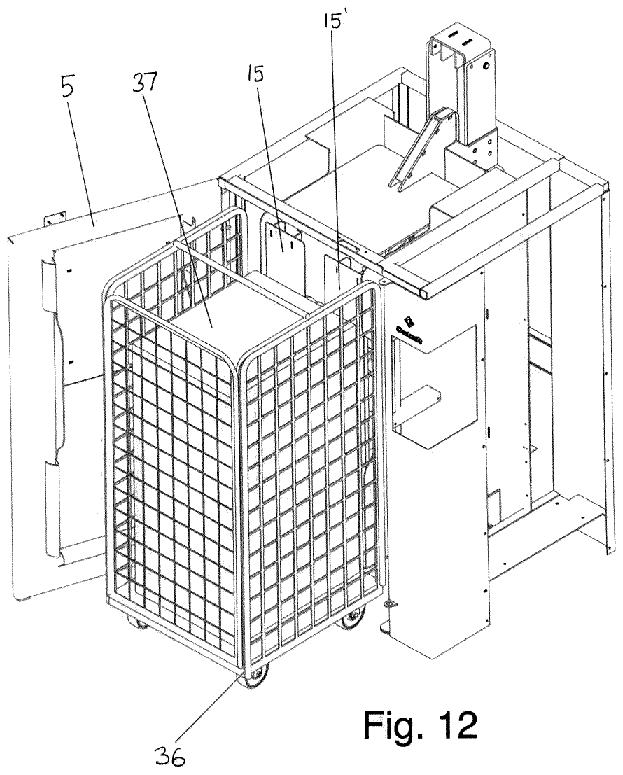

Activation of the ejection mechanism allows the pusher plates 15, 15′ to push the compacted waste 21 out of the inner compaction chamber 7. Since the roll cage 36 is on wheels, the presser plates 15, 15′ push the waste and cage 36 out of the apparatus together, until the roll cage, complete with compacted waste 37 is ejected from the apparatus, as illustrated in FIG. 12. The roll cage filled with compacted waste 37 can then be easily rolled away from the compacter apparatus and stored until it is collected for recycling or other disposal. No other manual handling of the bale of compacted waste is required. The main door 5 can then be closed and fresh loose waste introduced via the loading door 6.

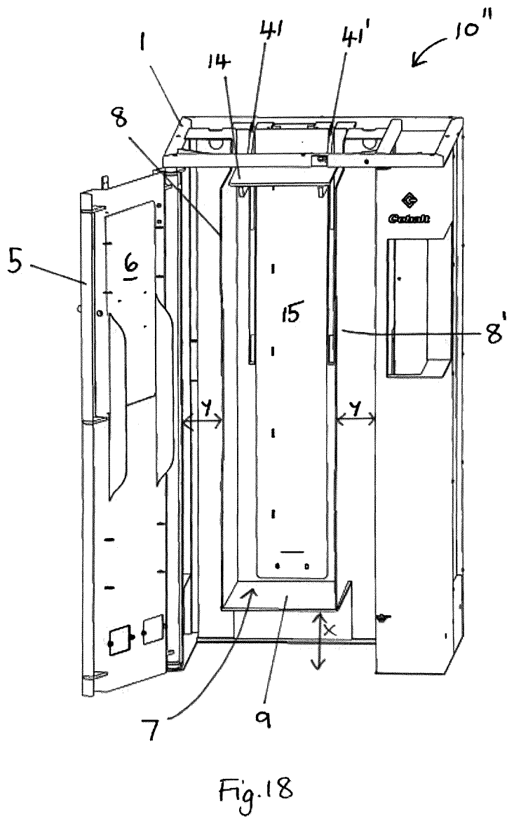

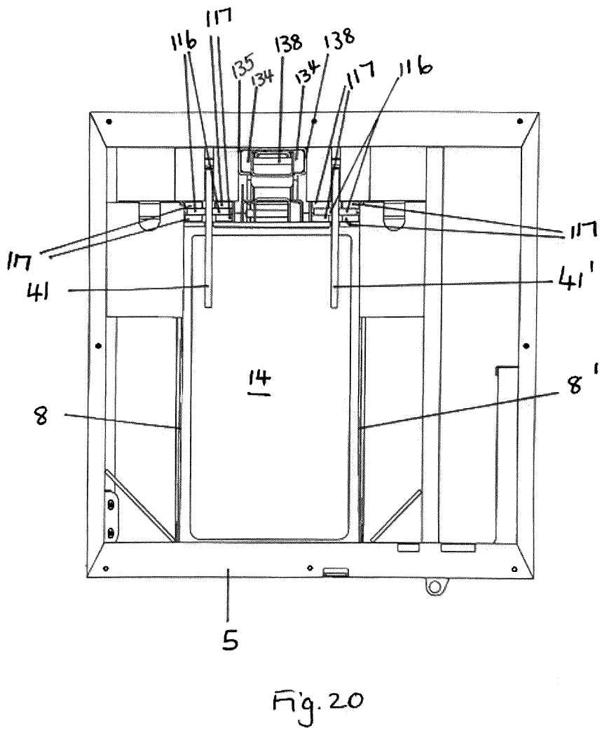

FIGS. 18 to 23 illustrate a further example of the apparatus of the invention, for use with smaller sized roll cages, 136. In this example only one pusher plate 15 is present. Like reference numerals are used to refer to like parts. A smaller roll cage may have a width of around 400 to 500 mm, and the sides of the inner chamber are spaced apart by an appropriate distance to allow the inner chamber to fit comfortably within the internal space of the roll cage.

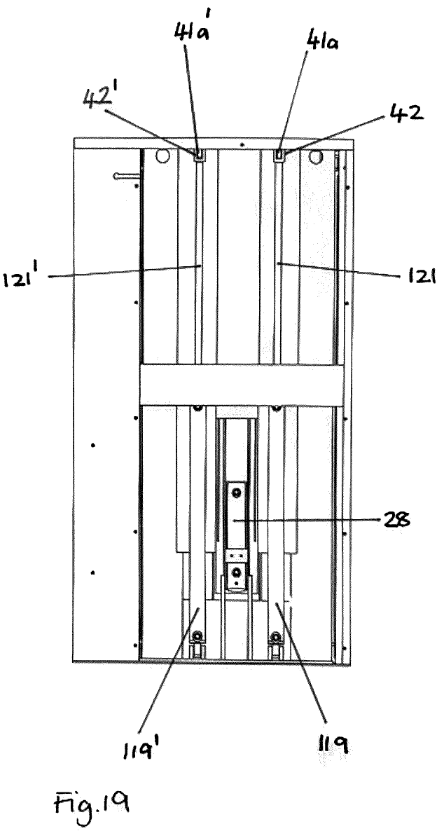

The apparatus works in the same way as previous examples, and includes an inner compaction chamber 7 which is raised above floor level to allow a roll cage to be rolled into the apparatus. The compaction plate assembly of this example includes a substantially horizontally oriented press plate 14 which is supported by a pair of substantially vertically oriented brackets 41, 41′. A rear portion 41a, 41a′ of each bracket is connected to the piston 121, 121′ of a hydraulic ram 119, 119′, preferably via a bolted connection indicated at numeral 42, as illustrated in the rear view of FIG. 19

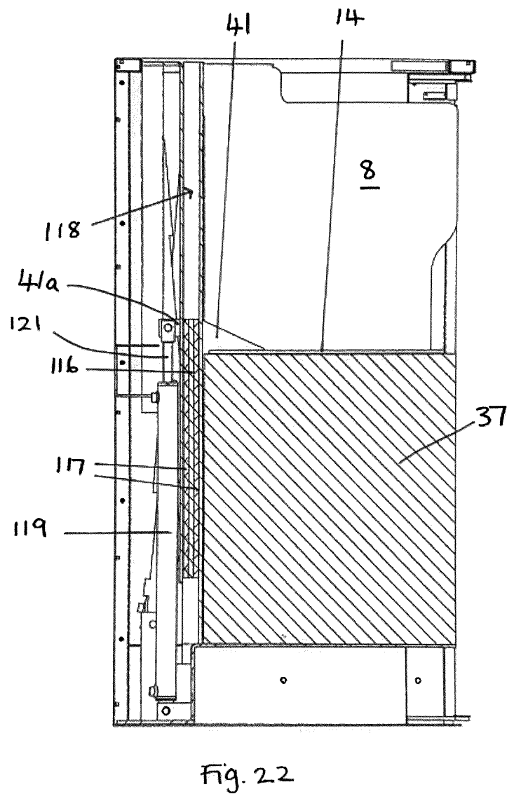

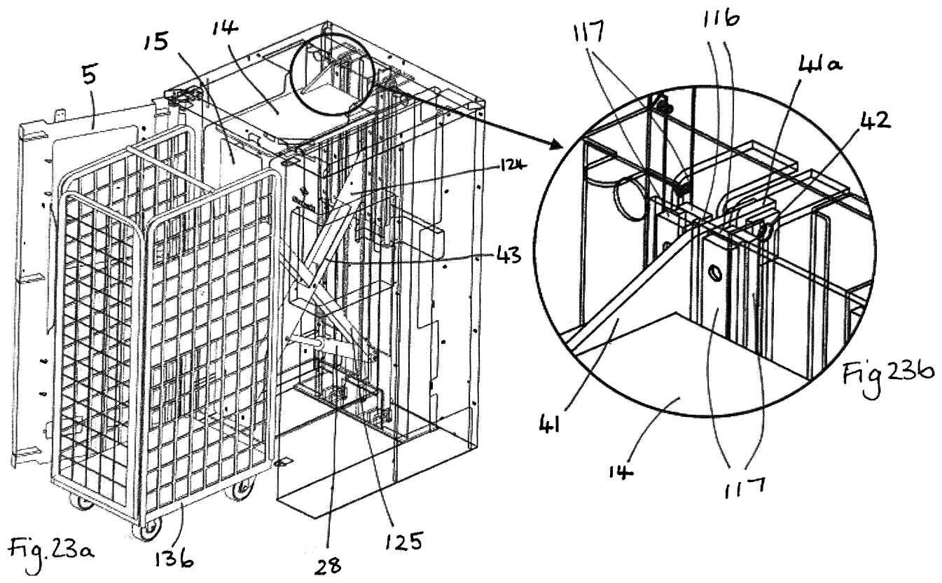

As shown in the enlarged view of FIG. 23b, each bracket 41, 41′ is connected to a substantially vertical arm 116, 116′ which is oriented at substantially 90 degrees to the bracket 41, 41′. Each arm is provided with two pairs of sliding elements 117 which are preferably bolted thereto and which are arranged to slide up and down within a vertical channel 118, shown best in the cross-sectional view of FIG. 22.

The hydraulic rams 119, 119′ act to move the press plate in a vertical direction, into and out of the compaction chamber. As the pistons 121, 121′ of the hydraulic rams retract vertically downwards, the sliding members 117, 117′ of the compaction plate assembly, along with the press plate 14 are also urged downwards. The stroke of the hydraulic ram is preferably between approximately 800 mm and 1000 mm. When the pistons 121, 121′ of the hydraulic rams 119, 119′ are in an extended position the press plate 14 rests towards the top of the inner chamber as shown in FIGS. 18, 21, 22 and 23. FIG. 22 is a cross-sectional view, illustrating the lowered position of the press plate 14 with the pistons of the hydraulic rams fully retracted.

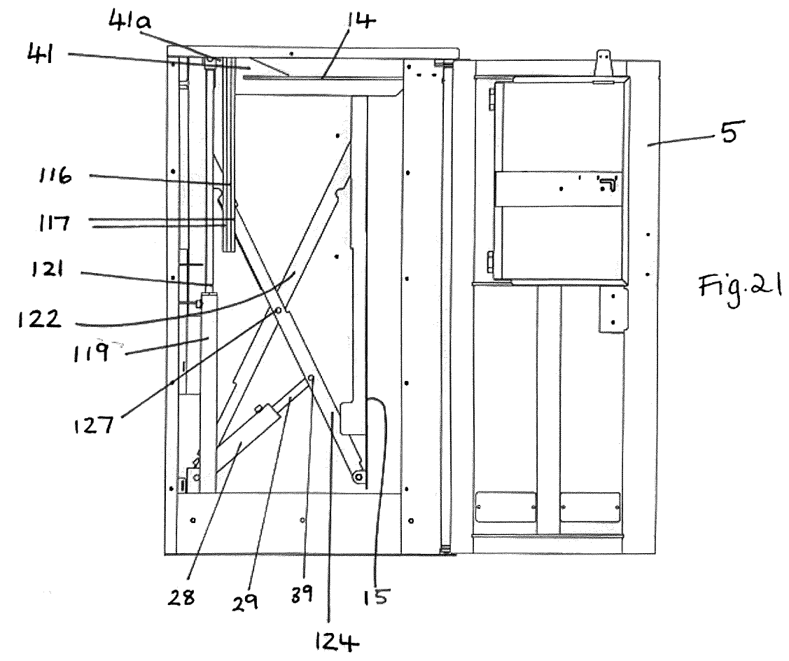

In this example, the mechanism for ejecting compacted waste from the apparatus comprises a single pusher plate 15 preferably extending longitudinally along the full height of the inner compaction chamber 7. As with the previous examples, the pusher plate 15 is mounted on a scissor arm mechanism which services to retract the pusher plate to the rear of the inner chamber, or to urge the pusher plate forwards. In FIG. 18 the pusher plate is shown in the retracted position, and in FIGS. 21, 23 and 24 the pusher plate 15 is shown in the extended position.

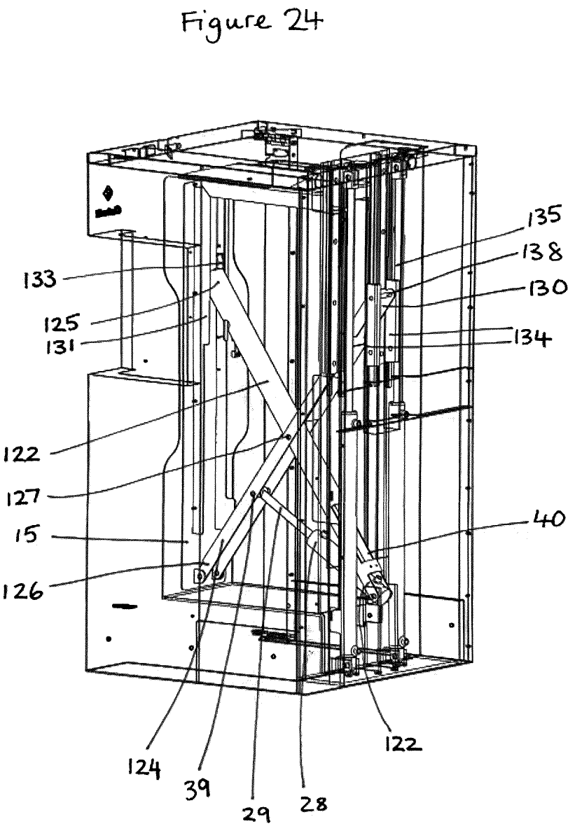

The scissor mechanism of this example is best illustrated in FIGS. 24 and 25. The pusher plate 15 is provided with a pair of scissor arms 122, 124 in the form of channel sections which are connected together at a midpoint 127 such that they may pivot with respect to one another. The first scissor arm 122 is pivotably mounted towards the rear of the outer frame at a first end 123, and is slidably mounted to the pusher plate 15 at a second end 125. In this example, the sliding member comprises a pair of spaced apart vertically oriented plates 133 which are fixed to the scissor arm channel via a substantially horizontal pin (not shown) such that the second scissor arm 124 may pivot with respect to the plates 133. The vertically oriented plates 133 forming the sliding member are located within a channel 131, such that the plates 133 can slide up and down within the channel 131.

The second scissor arm 124 is pivotably mounted to the bottom of the pusher plate 15 at a first end 126, and is slidably mounted to the rear of the outer frame at a second end 130. The slide mounting is better illustrated in FIG. 24. The sliding member comprises a pair of spaced apart vertically oriented plates 134 which are fixed to the scissor arm channel via a substantially horizontal pin 138 such that the second scissor arm 124 may pivot with respect to the plates 134. The vertically oriented plates 134 forming the sliding member are located within a channel 135, such that the plates 134 can slide up and down within the channel 135.

The scissor arm channel sections include cutaway sections 40, 43 which allow the scissor arm assembly to retract fully.

The scissor arm assembly works in the same way as described in the previous examples, via a hydraulic ram 28 which is pivotably mounted to the rear of the outer frame. The pusher plate 14 must be in the retracted position, at the top of the inner compaction chamber 7 before the pusher plate mechanism can be activated. The apparatus is used in an identical manner to the previous examples.

The apparatus of the invention allows a large force, typically in excess of 3 tonnes, to be exerted on the waste material within the inner compaction chamber. This means that one roll cage full of waste compacted using the apparatus of the invention is equivalent to six or seven roll cages full of loose waste material, leading to large savings in transport costs. Empty roll cages can be easily stacked together for transport, meaning fewer trucks are required to transport the combination of empty cages and waste.

1. A waste compacting apparatus comprising:
an outer framework;
an inner compacting chamber;
a compaction plate assembly; and
a waste ejection assembly for ejecting compacted waste from the apparatus;
wherein the inner compacting chamber comprises a pair of spaced apart side walls and a base, wherein the side walls and base are fixedly attached to the outer framework;
and wherein the inner compacting chamber is positioned such that the side walls and the base of the inner compacting chamber locate within an interior space of a roll cage when a roll cage is introduced into the framework;
and wherein the compaction plate assembly includes a press plate which is moveable between an upper position and a lower position within the inner compacting chamber such that waste within the inner compacting chamber is compacted by the press plate;
and wherein the waste ejection assembly comprises at least one pusher plate configured to move between a retracted position located at a rear region of the inner compaction chamber, and an extended position located at a front region of the inner compaction chamber.

2. A waste compacting apparatus according to claim 1, wherein the press plate is moveable by means of at least one press plate actuator.

3. A waste compacting apparatus according to claim 2 wherein the at least one press plate actuator is selected from the group comprising: a piston and cylinder actuator, a hydraulic ram, and a pneumatic ram.

4. A waste compacting apparatus according to claim 1, wherein the outer framework supports side walls spaced apart from the side walls of the inner compacting chamber.

5. A waste compacting apparatus according to claim 3, wherein the side walls of the inner compacting chamber are spaced apart from the side walls of the outer framework by a distance of between 100 and 300 mm.

6. A waste compacting apparatus according to claim 1, wherein the outer framework comprises a base and the base of the inner compacting chamber is spaced apart from the base of the outer framework by a distance of between 180 and 300 mm.

7. A waste compacting apparatus according to claim 1, wherein the at least one pusher plate is moveable by means of a scissor mechanism.

8. A waste compacting apparatus according to claim 1, wherein the at least one pusher plate is moveable by means of a pusher plate actuator.

9. A waste compacting apparatus according to claim 1, wherein the at least one pusher plate is moveable by means of a scissor mechanism and a pusher plate actuator.

10. A waste compacting apparatus according to claim 8, wherein each of the at least one pusher plate actuator is selected from the group comprising: a piston and cylinder actuator, a hydraulic ram, and a pneumatic ram.

11. A waste compacting apparatus according to claim 9, wherein the scissor mechanism comprises at least one pair of scissor arms associated with the or each pusher plate, the scissor arms being pivotably connected to each other.

12. A waste compacting apparatus according to claim 11, wherein the scissor arms are pivotably connected to each other at a midpoint of each scissor arm.

13. A waste compacting apparatus according to claim 11, wherein a first end of one of the scissor arms is pivotably mounted to the pusher plate and a second end thereof is slidably mounted to outer framework and a first end of the other of the scissor arms is slidably mounted to the pusher plate and a second end thereof is pivotably mounted to outer framework.

14. A waste compacting apparatus according to claim 1, wherein the waste ejection assembly comprises two pusher plates configured to move together between a retracted position located at a rear region of the inner compaction chamber, and an extended position located at a front region of the inner compaction chamber.

15. A waste compacting apparatus according to claim 1, wherein at least one of the outer framework and the inner compacting chamber is provided with a door.

16. A waste compacting apparatus according to claim 15, wherein the door is provided with a loading opening.

17. A waste compacting apparatus according to claim 16, wherein the loading opening is provided with a closing member.

18. A waste compacting apparatus according to claim 1, wherein the or each pusher plate of the waste ejection assembly is arranged substantially perpendicular to the press plate of the compaction plate assembly.

19. A method for compacting waste using the apparatus of claim 1 comprising the steps of:
introducing waste into the inner compacting chamber of the apparatus;
compacting the waste within the inner compacting chamber by actuating the compaction plate assembly and causing the press plate to move from a retracted position downwards within the inner compacting chamber; and
returning the press plate to the retracted position.

20. A method for compacting waste according to claim 19, comprising the further steps of:
d) introducing further waste into the inner compacting chamber; and
e) repeating steps b) and c) until the inner compacting chamber is full.

21. A method for compacting waste according to claim 20, comprising the further steps of:
(f) introducing an empty roll cage into the outer framework of the apparatus such that the inner compacting chamber is contained within the roll cage; and
(g) actuating the waste ejection assembly and causing the at least one pusher plate to push compacted waste out of the inner compacting chamber and into the roll cage, causing the roll cage filled with compacted waste to be pushed out of the apparatus; and
(h) returning the at least one pusher plate to a retracted position.
